(19) United States
(12) Patent Application Publication
(10) Pub. No.: US 2014/0190142 A1
(43) Pub. Date: Jul. 10, 2014

(54) APPARATUS COMPRISING RAKE WITH INTEGRATED TAMPER

(71) Applicant: Quirky, Inc., New York, NY (US)

(72) Inventors: Aaron Saxton, New York, NY (US); Michael Smith, West Hartford, CT (US); Gary Gillis, Ann Arbor, MI (US); Dan Turk, Brooklyn, NY (US)

(21) Appl. No.: 14/074,345

(22) Filed: Nov. 7, 2013

Related U.S. Application Data
(60) Provisional application No. 61/723,347, filed on Nov. 7, 2012.
(60) Provisional application No. 61/774,720, filed on Mar. 8, 2013.

(51) Int. Cl. A01D 7/00; E02D 3/046

(52) U.S. Cl. CPC A01D 7/00; E02D 3/046
USPC 56/400.05

(57) ABSTRACT

An exemplary aspect comprises an apparatus, comprising: a handle component comprising a first end and a second end; a collar slidably attached to the handle component; a tamper component affixed to the first end of the handle component; and a tines component affixed to the collar comprising individual tines extending through tine guides of the tamper component.

### CROSS-REFERENCE TO RELATED APPLICATIONS

This application claims priority under 35 U.S.C. 119(e) to U.S. Provisional Patent Application No. 61/723,347, filed Nov. 7, 2012, and to U.S. Provisional Patent Application No. 61/774,720, filed Mar. 8, 2013, each entitled “Apparatus Comprising Rake With Integrated Tamper.” The entire contents of each of the above-referenced applications are incorporated herein by reference.

### INTRODUCTION

An exemplary embodiment comprises an apparatus comprising a handle component, a tines component, and a tamper component for use in raking and tamping debris.

More specifically, an exemplary aspect may comprises an apparatus comprising: a handle component comprising a first end and a second end; a collar slidably attached to the handle component; a tamper component affixed to the first end of the handle component; and a tines component affixed to the collar comprising individual tines extending through tine guides of the tamper component.

In one or more exemplary apparatus embodiments: (1) the apparatus is in a rake configuration when the collar is in an extended position, and the apparatus is in a tamper configuration when the collar is in a retracted position; (2) when the collar is moved towards the first end to an extended position, the individual tines of the tines component flare into a rake configuration; (3) when the collar is moved towards the second end to a retracted position, the individual tines are pulled toward each other into a tamper configuration; (4) when the collar is between the retracted position and the extended position, the apparatus is in an intermediate configuration between the rake configuration and the tamper configuration; (5) rake teeth extend from the individual tines of the tines component; (6) ribbed portions are disposed on a surface of said tamper component opposite from the second end of the handle component; (7) the tine guides comprise apertures in the tamper component through which the individual tines extend; (8) a locking mechanism is integrated with the collar that locks the collar in place on the handle component; (9) the locking mechanism comprises a lever comprising a release end and a locking end; (10) pushing on the release end lifts the locking end away from the handle component allowing the collar to slide; (11) the locking mechanism comprises a spring disposed under the release end of the lever and a locking pin extending from the locking end of the lever; (12) the locking mechanism comprises a pivoting pin disposed between the release end and the locking end of the lever, and the spring pushes the release end away from the handle component, pushing the locking end and the locking pin towards the handle component about the pivoting pin; (13) the handle component comprises a plurality of pin receiving holes that receive the locking pin, and the pin receiving holes correspond to at least one of a rake configuration, a tamper configuration, and an intermediate configuration between the rake configuration and the tamper configuration; (14) a hole is disposed at the second end of the handle component opposite to the tines component; (15) a grasping portion is disposed at the second end of the handle component; and (16) the grasping portion is made of rubber.

Another exemplary aspect may comprise a method of operating an apparatus comprising a handle component, a tines component, a tamper component, and a collar, the method comprising: extending the collar towards the tamper component to flare the tines component into a rake configuration and retracting the collar away from the tamper component to retract the tines component into a tamper configuration.

### BRIEF DESCRIPTION OF THE DRAWINGS

FIGS. 1A-1B depict an exemplary embodiment comprising a rake with an integrated tamper.

FIGS. 2-3 depict perspective views of exemplary embodiments.

FIG. 4 depicts a top view of an exemplary embodiment.

FIG. 5 depicts a perspective view of an exemplary embodiment comprising ribbed portions.

FIG. 6 depicts a bottom view of an exemplary embodiment comprising tine guides.

FIGS. 7-14 depict various views of exemplary embodiments.

FIG. 15 depicts a perspective view of an exemplary embodiment comprising a locking mechanism.

FIGS. 16-17 depict exemplary embodiments.

FIGS. 18A-18C depict side and perspective views of an exemplary embodiment.

FIGS. 19-27 depict various views of exemplary embodiments.

### DETAILED DESCRIPTION OF CERTAIN EXEMPLARY EMBODIMENTS

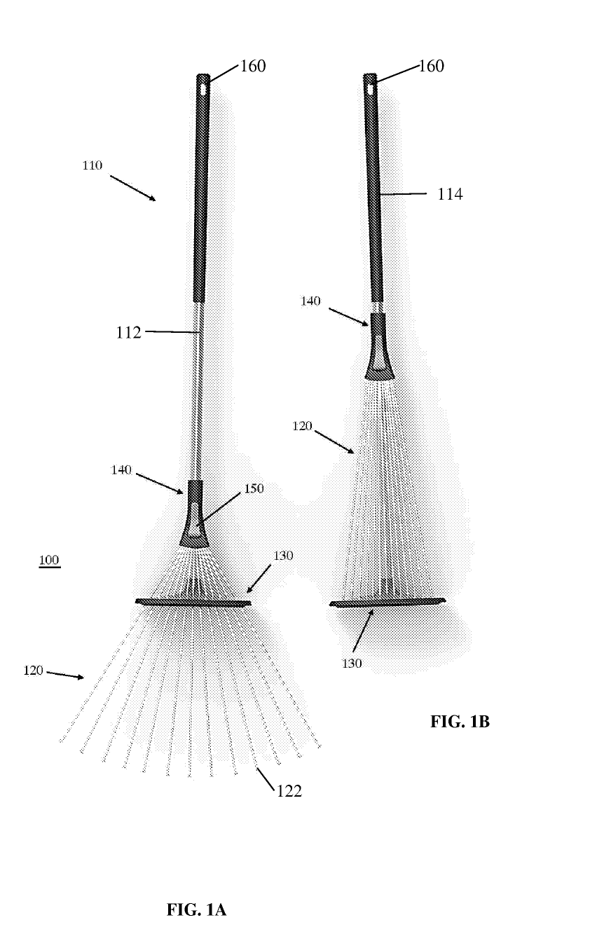

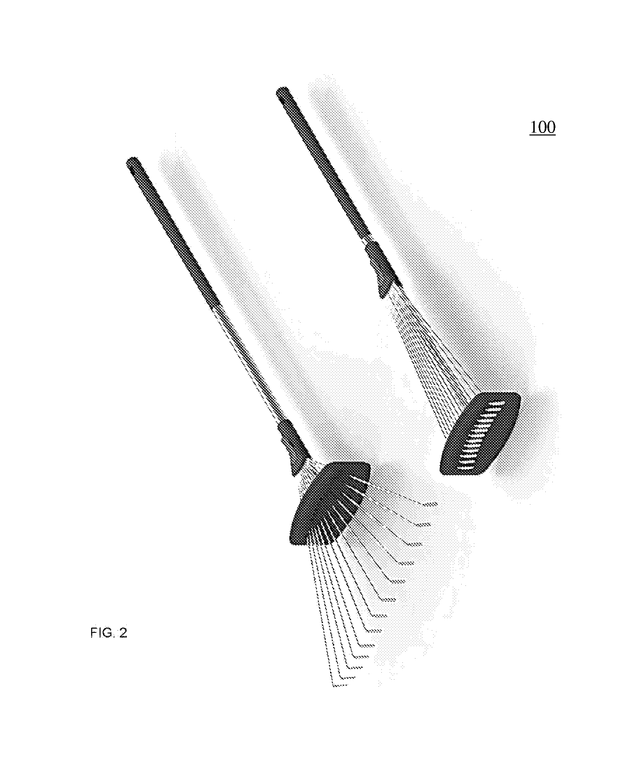

FIGS. 1A-1B depict an exemplary embodiment comprising a rake with an integrated tamper. In this embodiment, apparatus 100 comprises a handle component 110, a tines component 120, and a tamper component 130. Handle component 110 comprises a sliding portion 112 and a grasping portion 114. Sliding portion 112 is disposed at a first end of handle component 110 and grasping portion 114 is disposed at a second end of handle component 110.

In an exemplary embodiment, tamper component 130 is affixed to the first end of handle component 110. Tines component 120 is affixed to a collar 140. Collar 140 is slidably attached to sliding portion 112 of handle component 110.

As depicted in FIG. 1A, when collar 140 is moved to an extended position, individual tines 122 of tines component 120 are flared out by tamper component 130 into a rake configuration. Individual tines 122 are rotatably affixed to collar 140 such that individual tines 122 may flare and retract between the configurations described herein.

As depicted in FIG. 1B, when collar 140 is moved to a retracted position, i.e., collar 140 is moved towards the grasping portion 114 of handle component 110 away from tamper component 130, individual tines 122 are pulled toward each other and tamper component 130 rests at the end of tines component 120, placing apparatus 100 into a tamper configuration. When collar 140 is moved to an intermediate configuration (not shown), collar 140 is between the retracted position and the extended position. In the intermediate configuration, individual tines 122 of tines component 120 are closer together than in the rake configuration and farther apart than in the tamper configuration, allowing a user to rake yard debris in a more concentrated manner or in tighter spaces, such as garden beds.

In certain exemplary embodiments, tines component 120 comprises at least ten individual tines 122, or thirteen individual tines 122, or fifteen individual tines 122. However, any suitable number of individual tines 122 may be used.

Exemplary dimensions of tines component 120 comprise: 532 mm wide and 1398 mm long in the rake configuration; 365 mm wide in the intermediate configuration; and 232 mm wide and 1061 mm long in the tamper configuration.

Additional exemplary dimensions of tines component 120 comprise: 519 mm wide and 1745 mm long in the rake configuration; 365 mm wide in the intermediate configuration; and 164 mm wide and 1330 mm long in the tamper configuration.

In an exemplary embodiment, apparatus 100 comprises a hole 160 disposed at the second end of handle component 110 opposite to tines component 120 enabling apparatus 100 to hang on a nail or hook, for convenient storage.

In exemplary usage, apparatus 100 provides an efficient method to rake and manually compress light yard debris (for example, lawn clippings, twigs, or leaves) into lawn and leaf bags. A user may extend collar 140 and use the rake configuration to rake leaves, for example. Then when the user has loaded the leaves into a leaf bag or trash can, the user may retract collar 140 to implement the tamper configuration to compress the leaves.

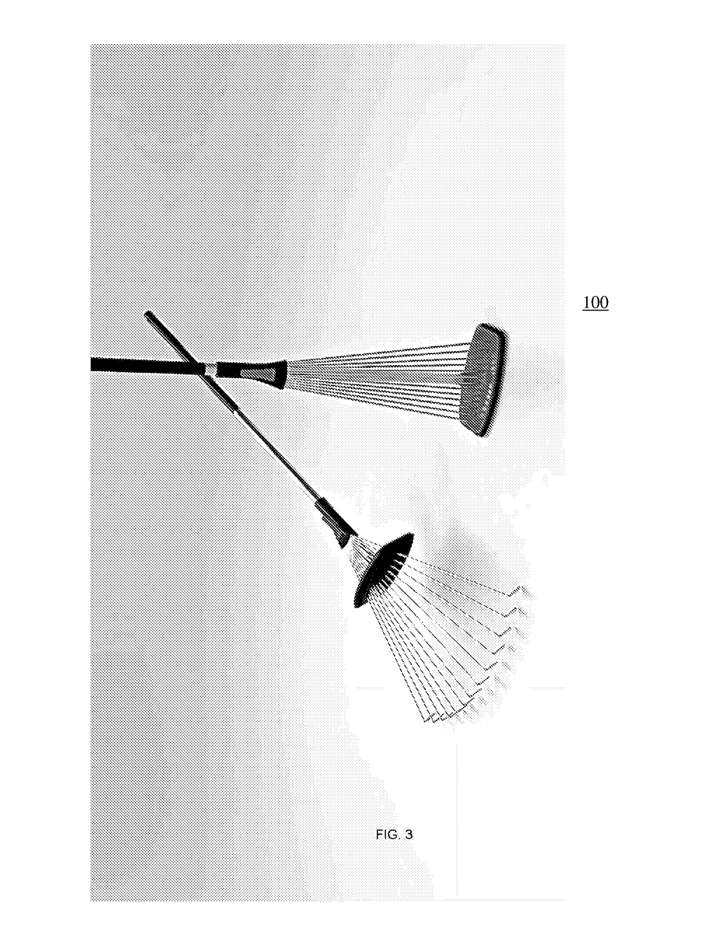

FIGS. 2-3 depict perspective views of exemplary embodiments.

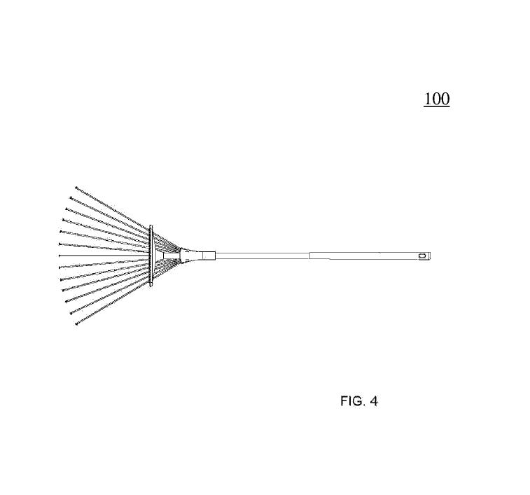

FIG. 4 depicts a top view of an exemplary embodiment.

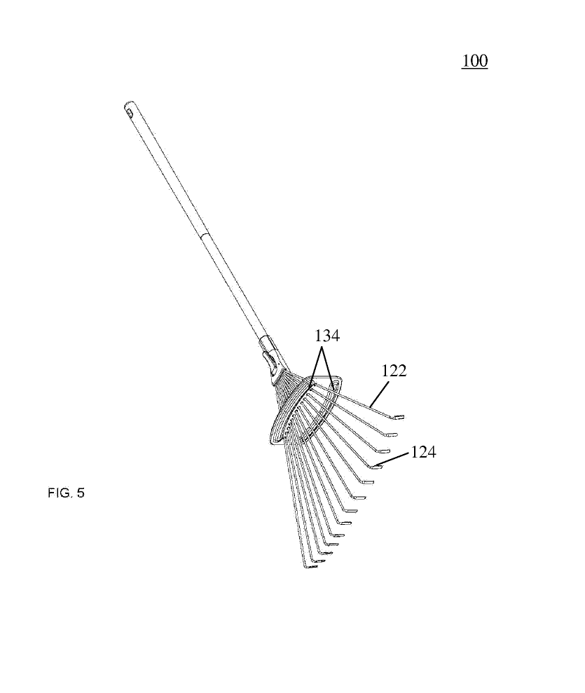

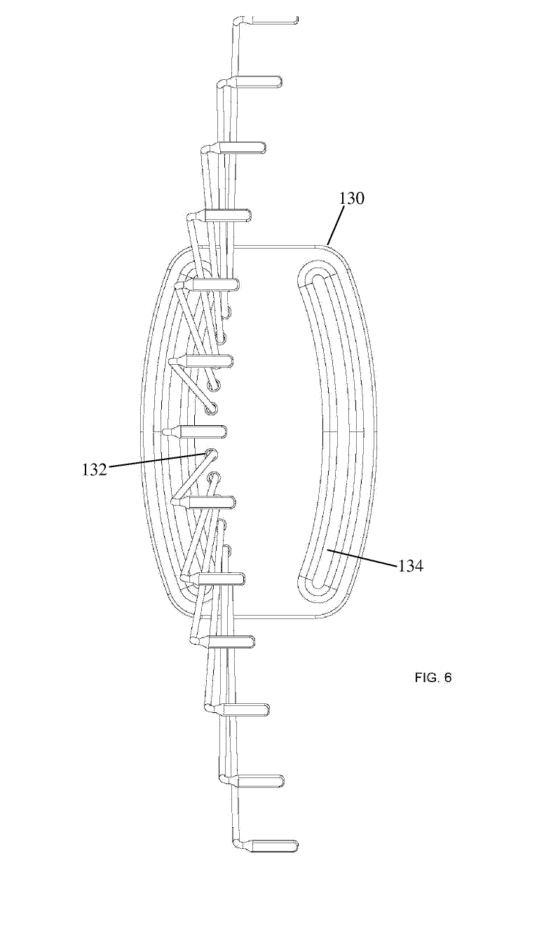

FIG. 5 depicts a perspective view of apparatus 100 comprising rake teeth 124 extending from individual tines 122 of tines component 120. Rake teeth 124 may extend from individual tines 122 at a right angle or in an arcuate manner. Rake teeth 124 enable tines component 120 to catch and grab yard debris when apparatus 100 is in use. Rake teeth 124 also prevent individual tines 122 from being pulled out of tine guides 132, which are described with respect to FIG. 6.

In an exemplary embodiment, in the tamper configuration, rake teeth 124 tuck under ribbed portions 134 protruding from the bottom of tamper component 130. That is, ribbed portions 134 are disposed on a surface of tamper component 130 opposite from the second end of handle component 110. A plurality of ribbed portions 134 are disposed on opposite sides of tines component 120. Ribbed portions 134 extend beyond rake teeth 124 when apparatus 100 is in the tamper configuration. With ribbed portions 134 contacting the ground, apparatus 100 is able to stand upright by itself. In exemplary usage, ribbed portions 134 prevent leaves and debris from sticking to a surface of tamper component 130.

FIG. 6 depicts an exemplary embodiment comprising individual tines 122 extending through tine guides 132. Individual tines 122 are guided between the rake configuration and the tamper configuration by tine guides 132. Tine guides 132 may comprise apertures in tamper component 130. Alternatively, tine guides 132 may comprise a ribbed construction of tamper component 130, with a plurality of indented guides in tamper component 130 within which individual tines 122 rest when set to a particular configuration and run through when changing between configurations.

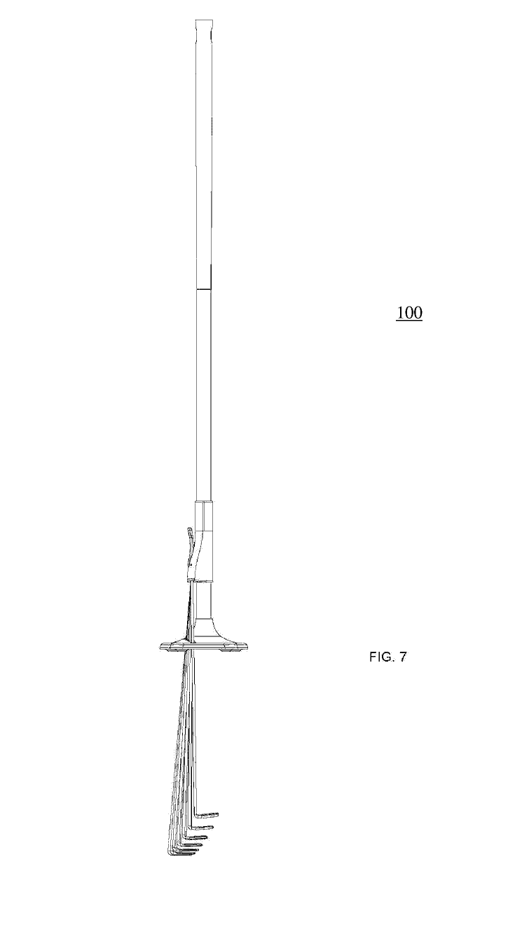

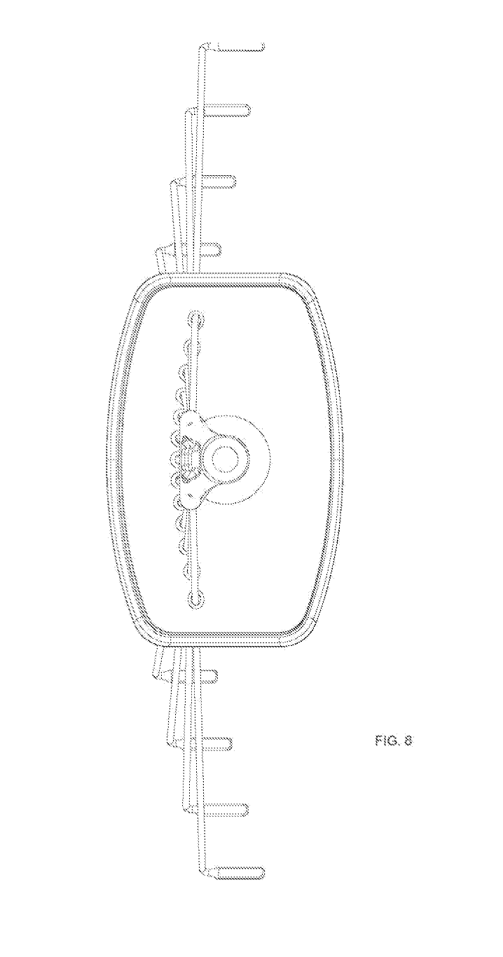

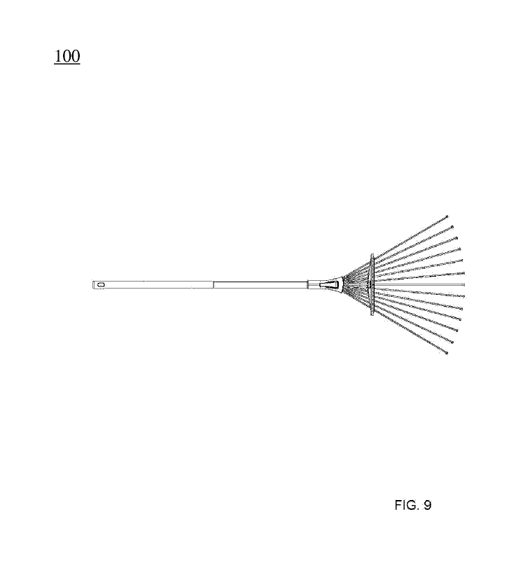

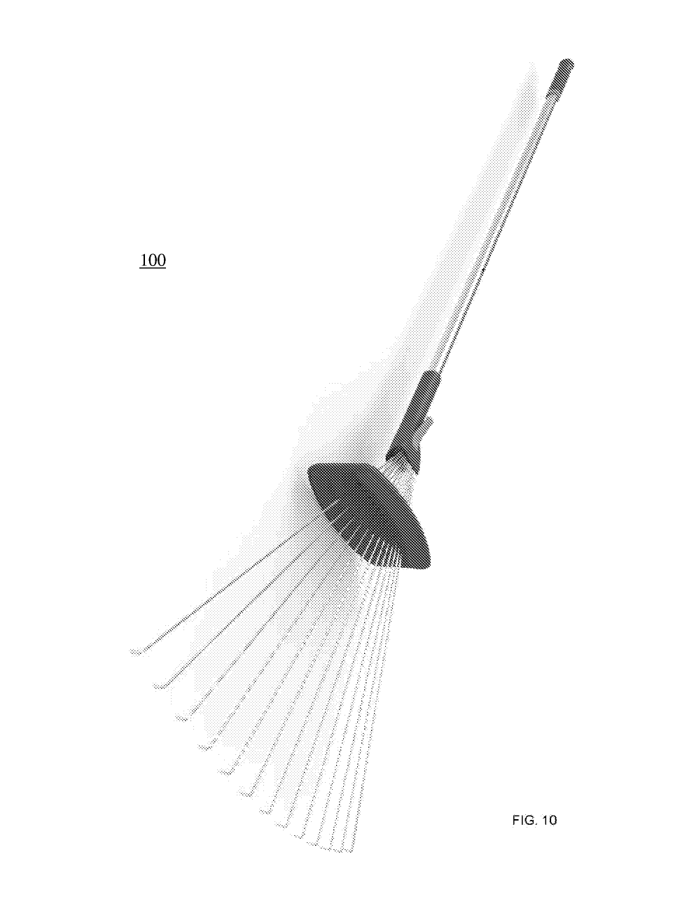

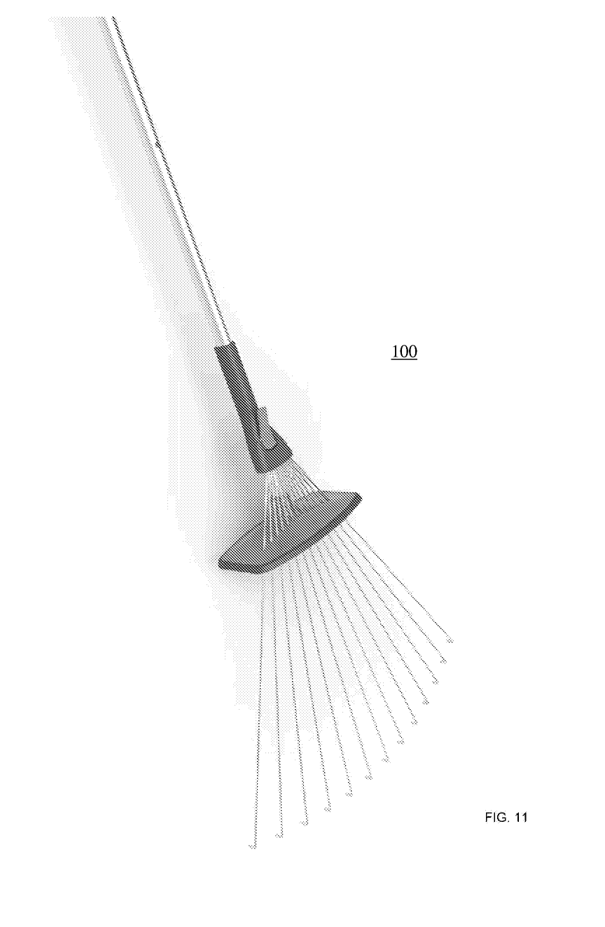

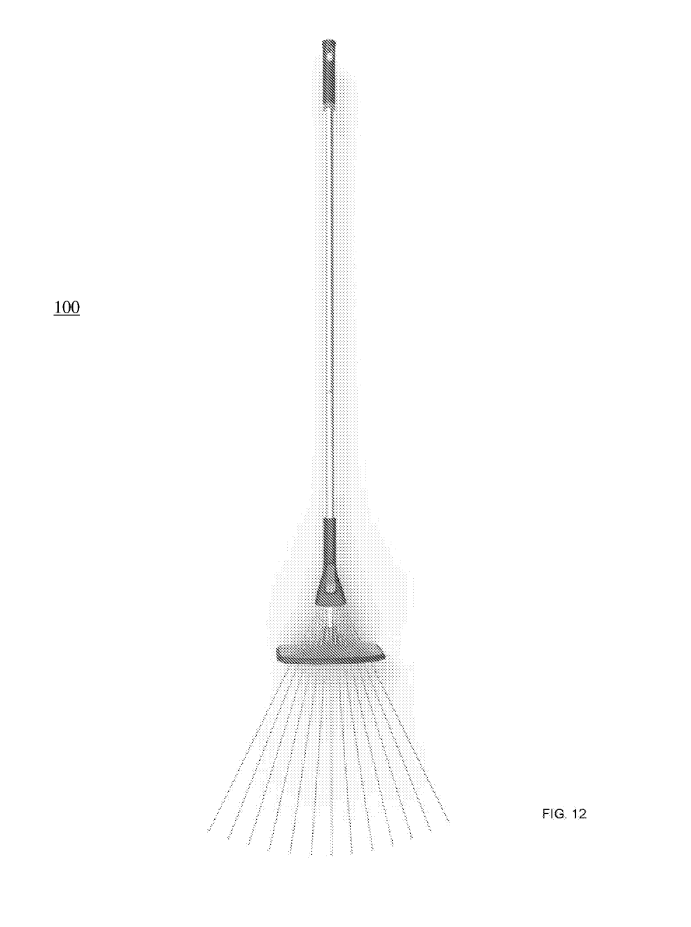

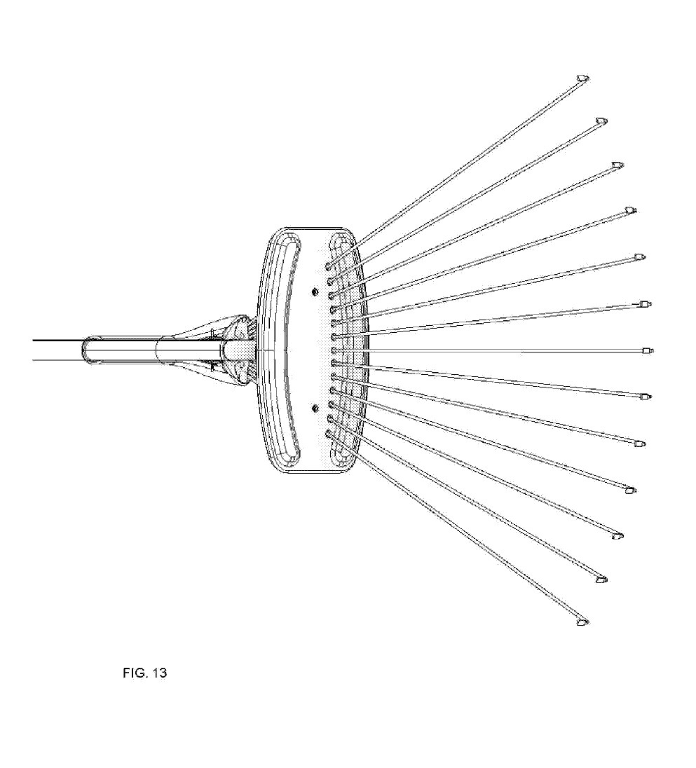

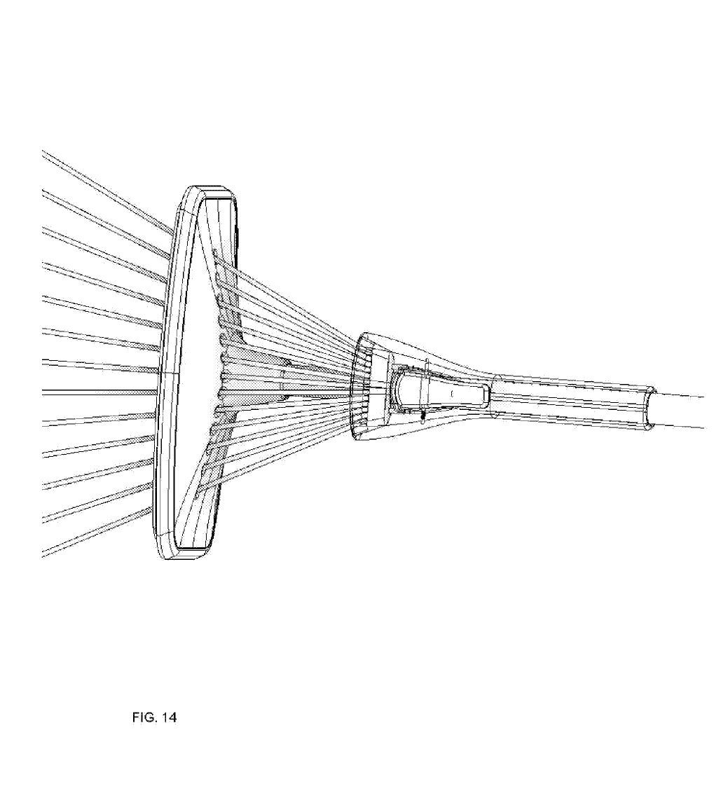

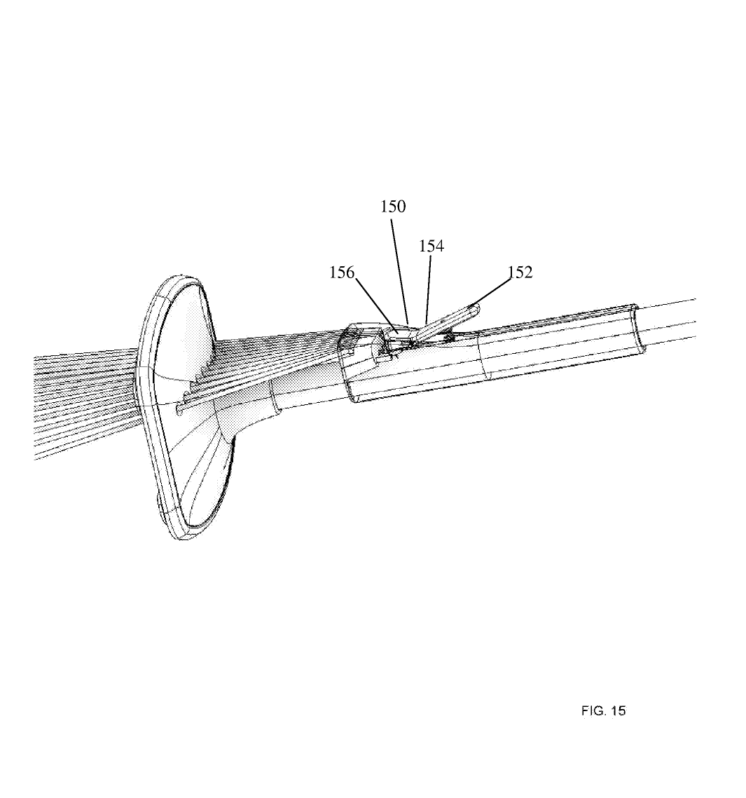

FIGS. 7-14 depict various views of exemplary embodiments.

FIG. 15 depicts an exemplary embodiment comprising a locking mechanism 150 integrated with collar 140. Collar 140 is held in place on handle component 110 by locking mechanism 150 when locking mechanism 150 is in a locked position. Locking mechanism 150 comprises a lever 154, a spring 157 and a pivoting pin 159. In an exemplary embodiment, spring 157 may comprise a compression spring or a torsion spring. However, those skilled in the art will understand that various springs may be used. Lever 154 comprises a release end 152, a locking end 156 and a locking pin 158. Collar 140 may be retracted by pressing on release end 152 of lever 154 (or, for example, lifting a lever or button) of locking mechanism 150 and sliding collar 140 inward away from tamper component 130. A user may push down on locking end 156 of lever 154 (or, for example, release the lever or button) in order to lock collar 140 in place.

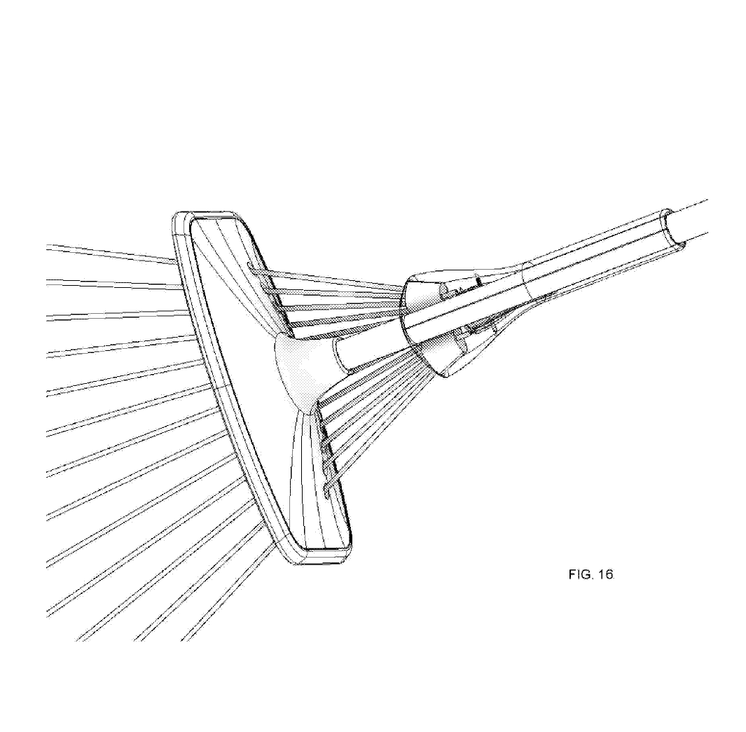

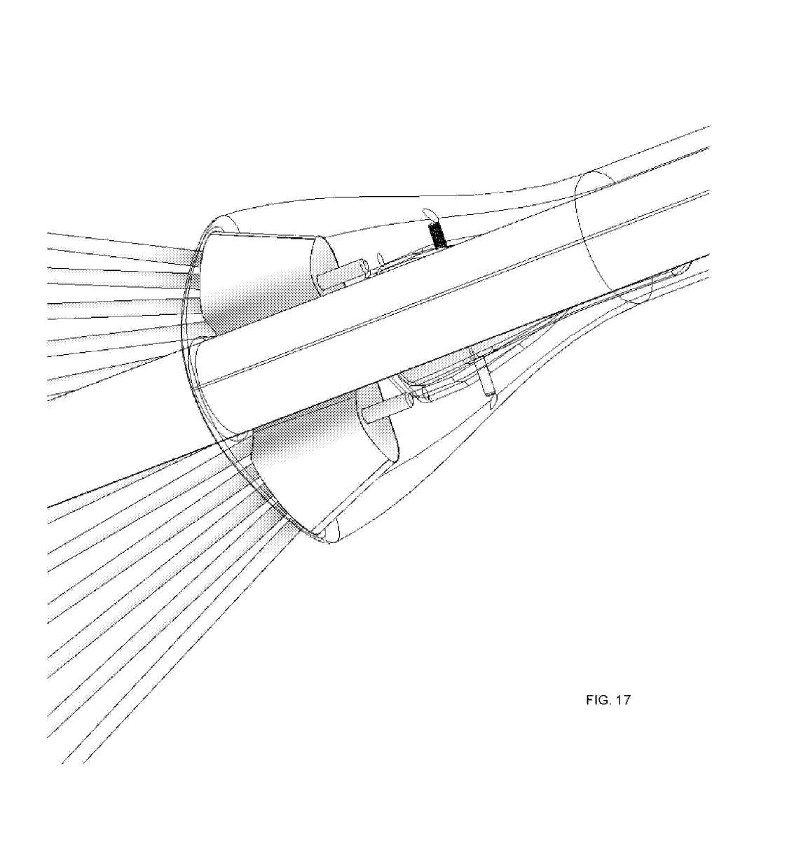

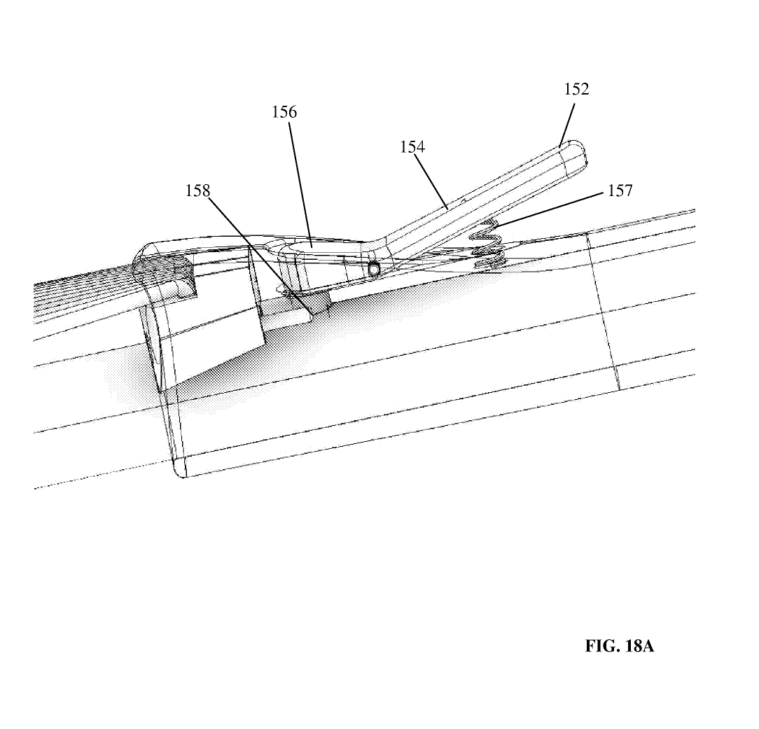

FIGS. 16-17 depict exemplary embodiments.

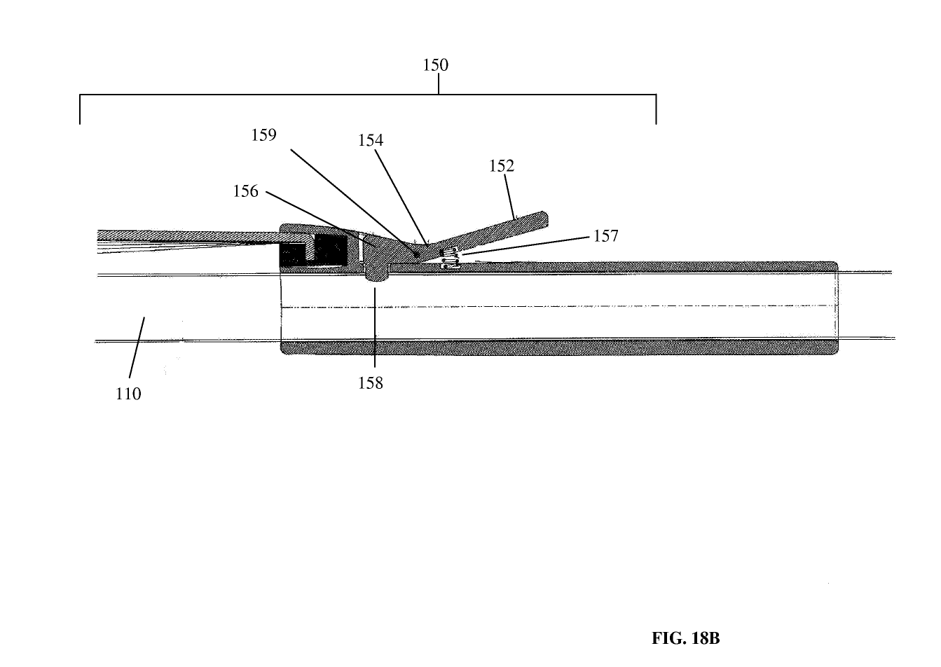

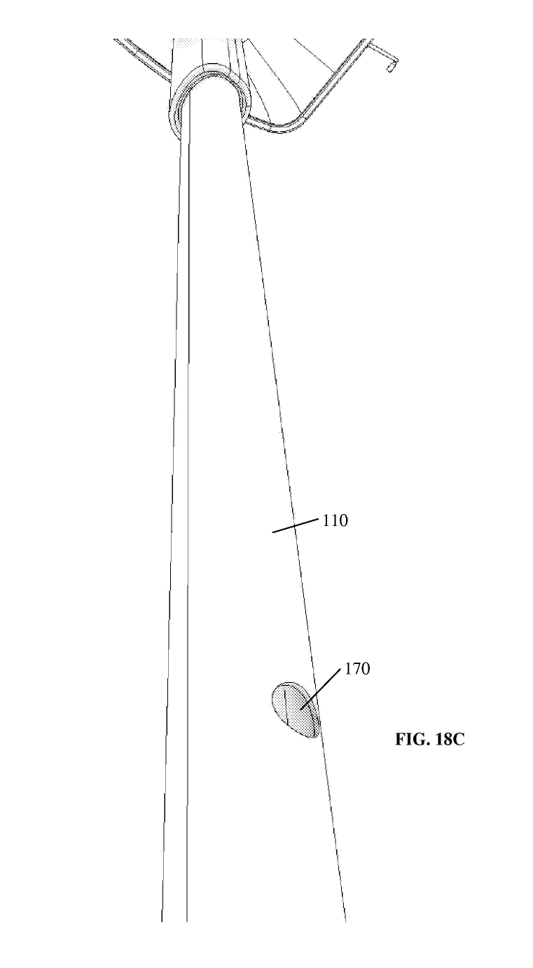

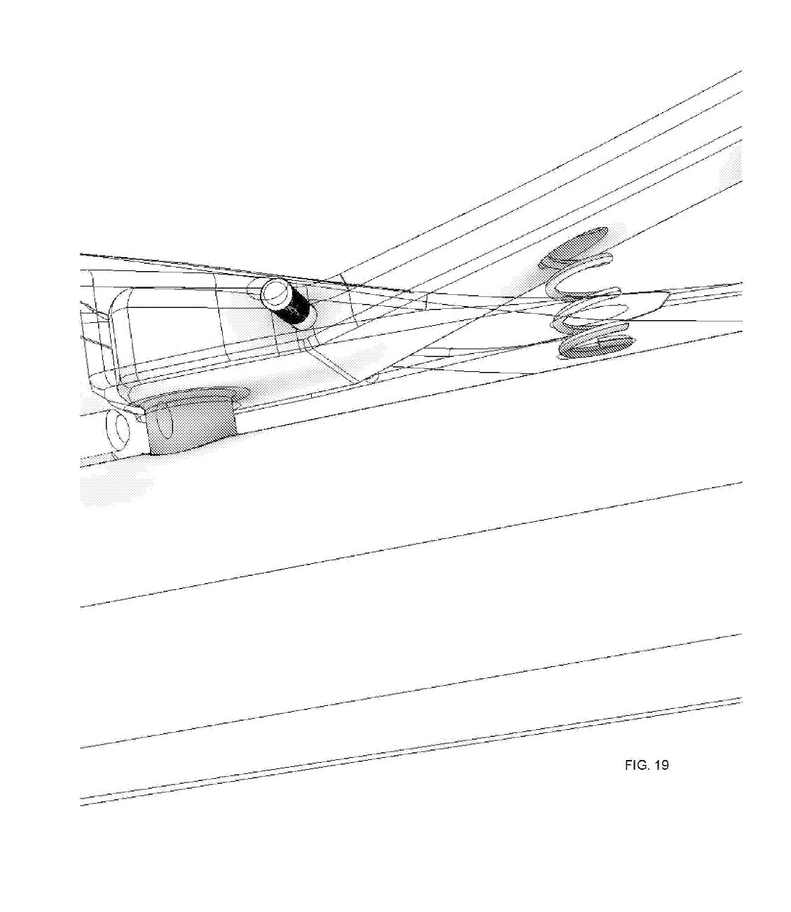

FIGS. 18A-18B depict side views of an exemplary embodiment of locking mechanism 150. Locking mechanism 150 may comprise spring 157 disposed under release end 152. Locking mechanism 150 may also comprise locking pin 158 extending from lever 154. Pivoting pin 159 is disposed within lever 154 between release end 157 and locking end 156. FIG. 18C depicts locking pin 158 extending into one of a plurality of pin receiving holes 170 in handle component 110 locking collar 140 in place. Spring 157 pushes release end 152 away from handle component 110, pushing locking end 156, and locking pin 158, towards handle component 110. FIG. 18C depicts one of the pin receiving holes 170 in handle component 110, in an embodiment where collar 140 uses a pin and hole locking mechanism.

In an exemplary embodiment, handle component 110 comprises pin receiving holes 170 located in positions along sliding portion 112 that enable collar 140 to be locked in at least one of the rake configuration, the intermediate configuration and the tamper configuration. That is, apparatus 100 may locked in the rake configuration when collar 140 is moved to one of the pin receiving holes 170 nearest to the second end of handle component 110. To adjust apparatus 100 to the intermediate configuration, the user presses release end 152 of lever 154, pivoting locking end 156 away from handle component 110 about pivoting pin 159, which pulls locking pin 158 out of the pin receiving hole 170 to release the locking mechanism 150. Collar 140 may then be moved to one of the pin receiving holes 170 corresponding to the intermediate configuration and the tamper configuration.

In an exemplary embodiment, a pressure lock may be used for locking mechanism 150. In this embodiment, a lever is used that presses against the shaft when pressed down and locks with pressure. Pressure pins, allowing a user to lock the rake in multiple configurations, may also be used for the locking mechanism. Those skilled in the art will understand that the invention described herein is not limited to any particular locking mechanism and that any suitable locking mechanism may be used.

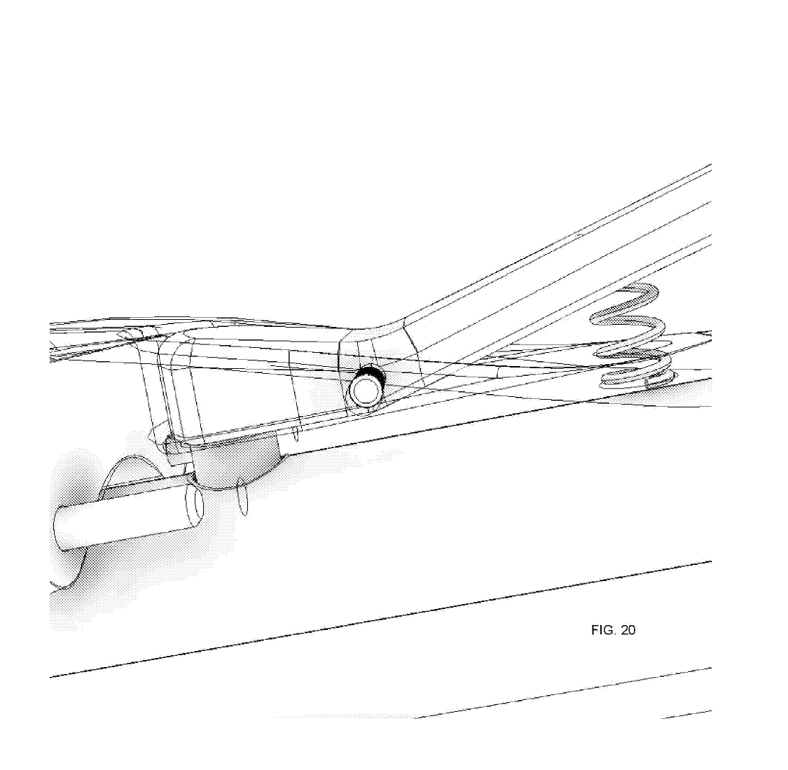

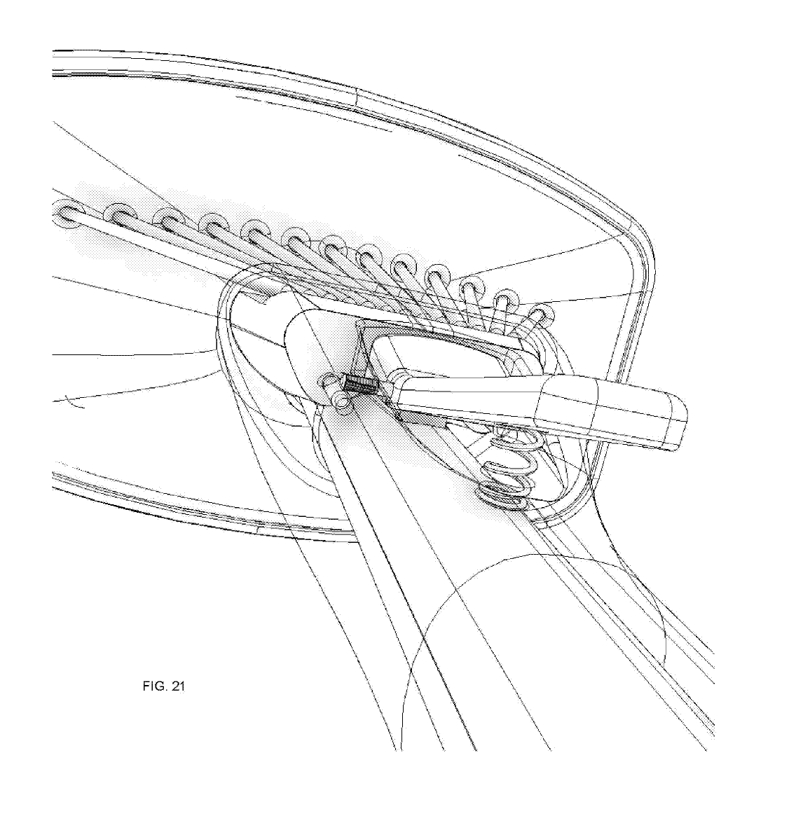

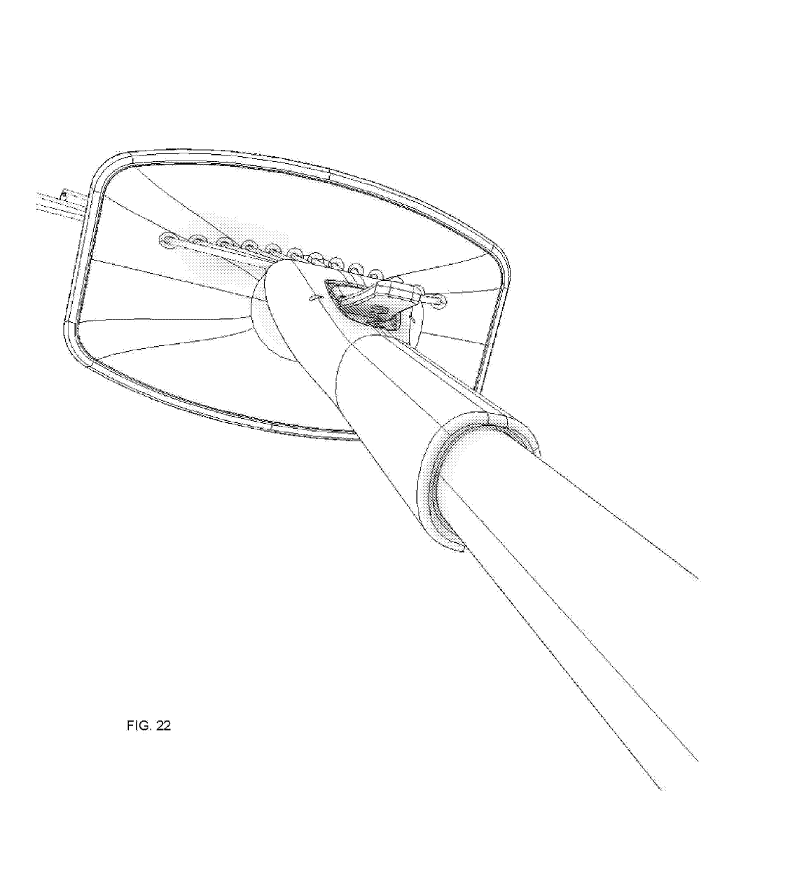

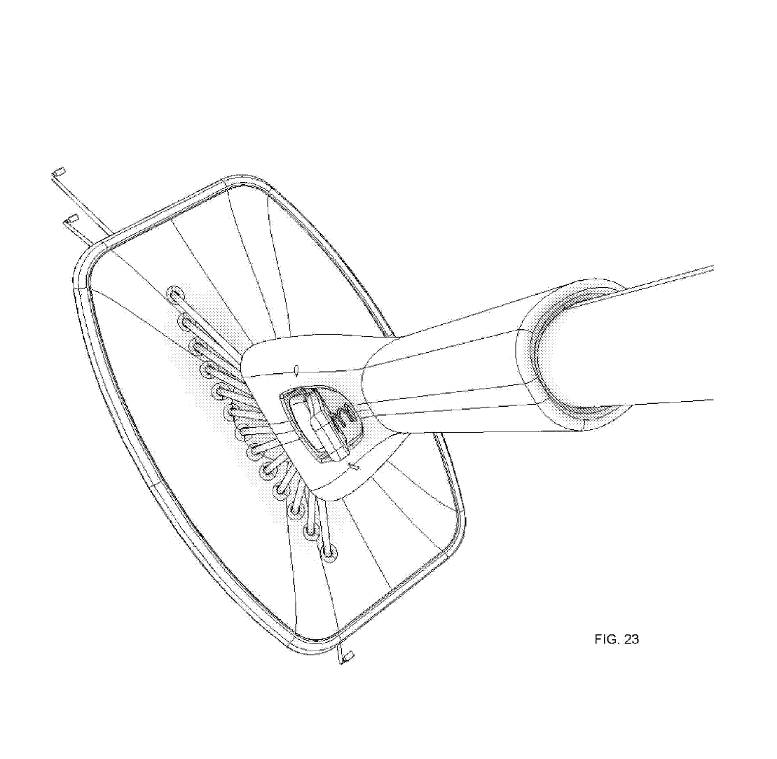

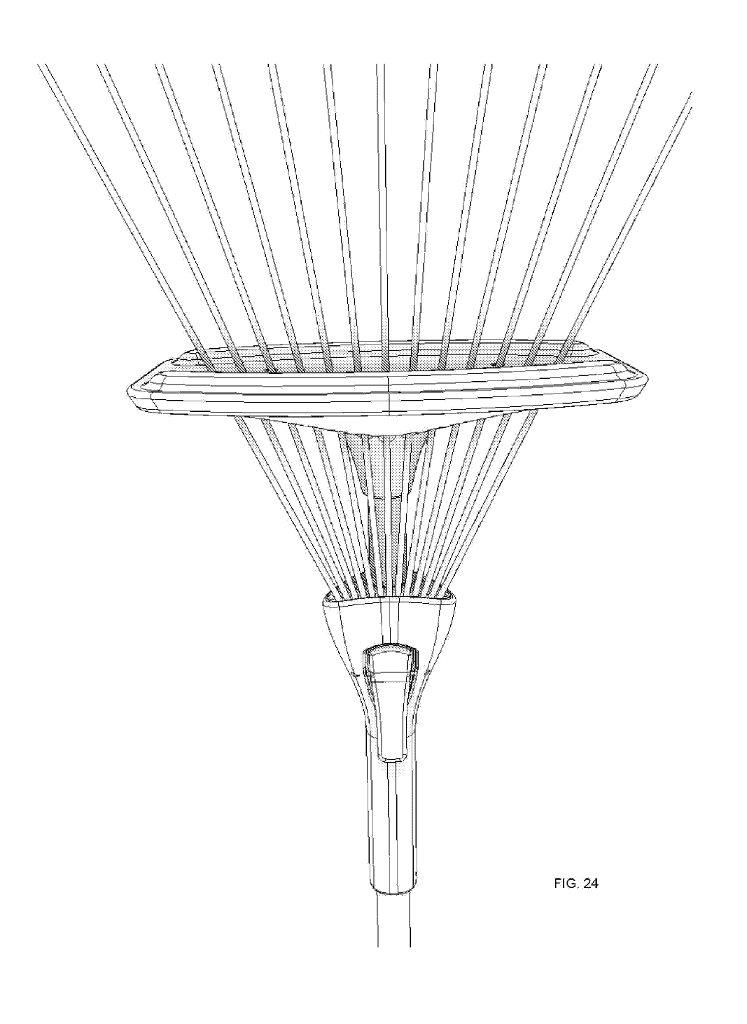

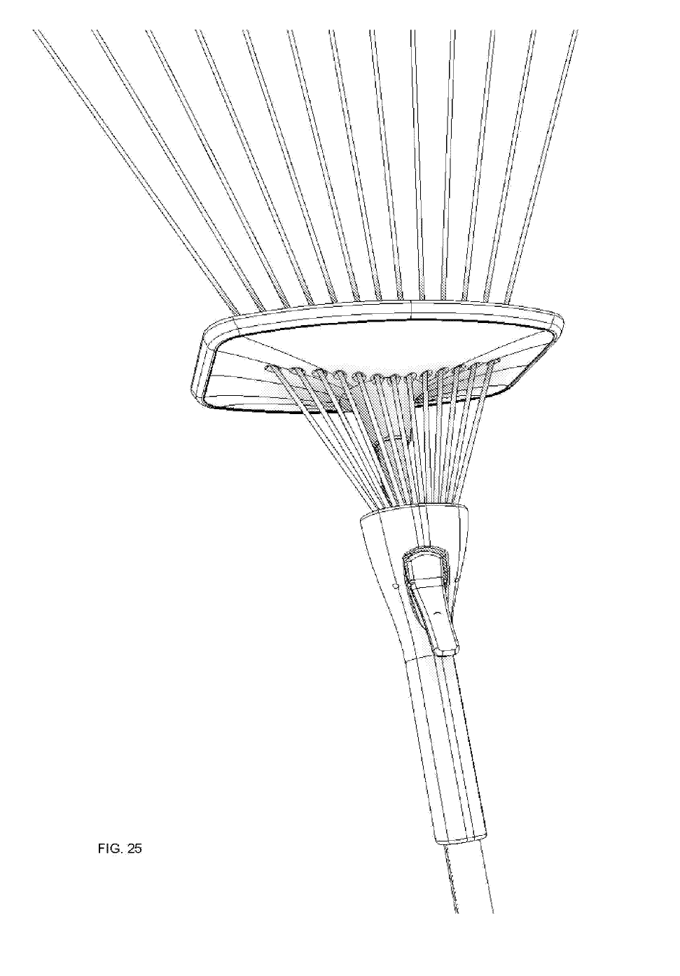

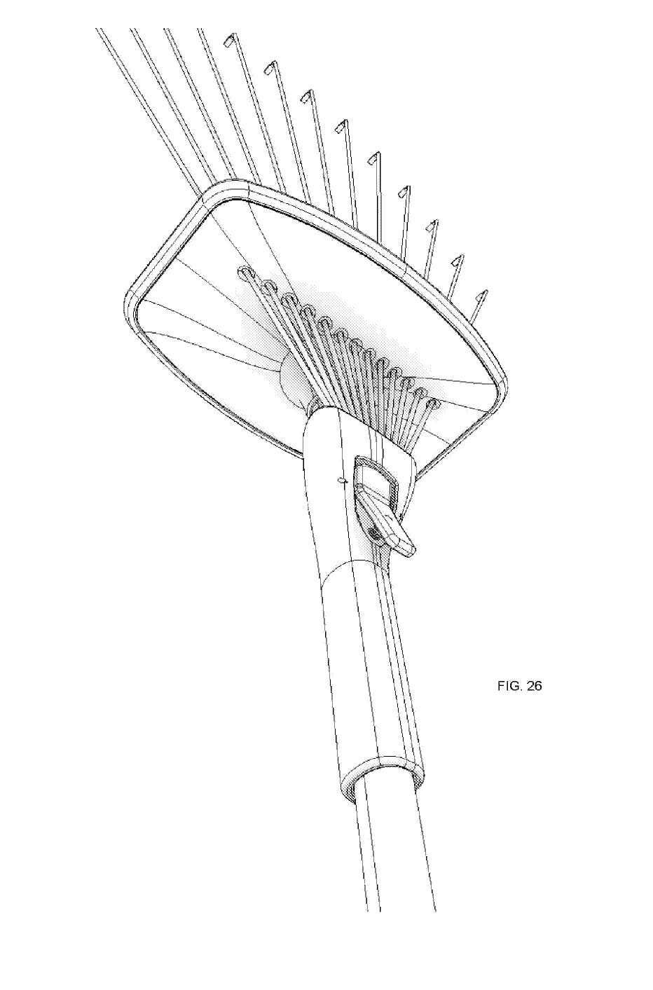

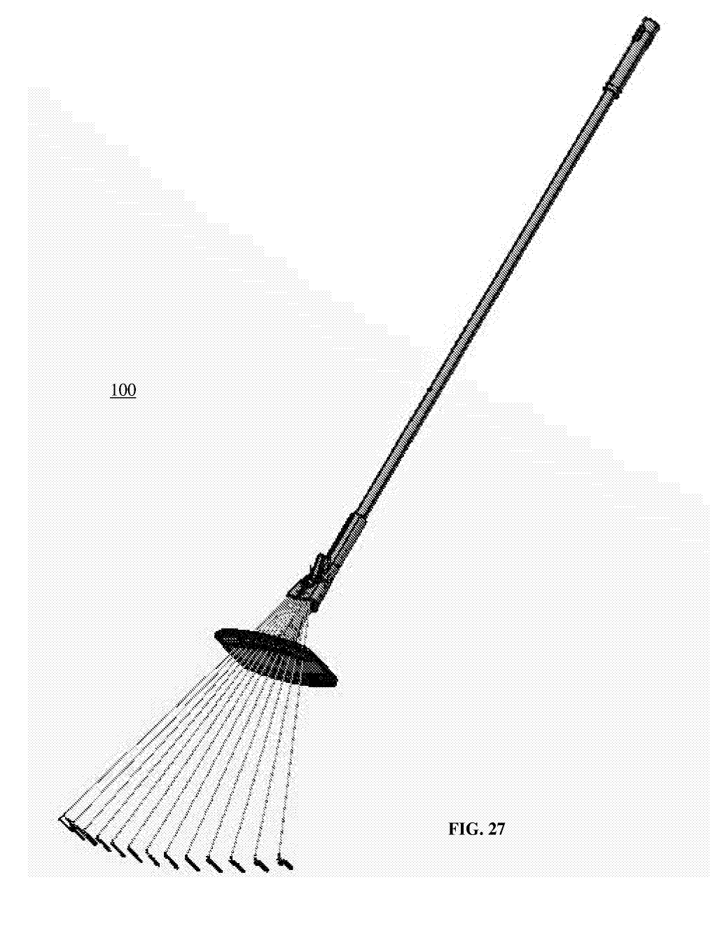

FIGS. 19-27 depict various views of exemplary embodiments.

Exemplary construction of apparatus 100 comprises: handle component 110 made of aluminum; tines component 120 made of steel; grasping portion 114 made of rubber, such as Thermoplastic Elastomer (TPE); tamping component 130 made of plastic; and lever 154 made of plastic. However, any suitable materials may be used.

While certain exemplary aspects and embodiments have been described herein, many alternatives, modifications, and variations will be apparent to those skilled in the art. Accordingly, exemplary aspects and embodiments set forth herein are intended to be illustrative, not limiting. Various modifications may be made without departing from the spirit and scope of the disclosure.

We claim:

1. An apparatus comprising:
a handle component comprising a first end and a second end;
a collar slidably attached to the handle component;
a tamper component affixed to the first end of the handle component; and
a tines component affixed to the collar comprising individual tines extending through tine guides of the tamper component.

2. The apparatus of claim 1, wherein the apparatus is in a rake configuration when the collar is in an extended position, and wherein the apparatus is in a tamper configuration when the collar is in a retracted position.

3. The apparatus of claim 1, wherein when the collar is moved towards the first end to an extended position, the individual tines of the tines component flare into a rake configuration.

4. The apparatus of claim 3, wherein when the collar is moved towards the second end to a retracted position, the individual tines are pulled toward each other into a tamper configuration.

5. The apparatus of claim 4, wherein when the collar is between the retracted position and the extended position, the apparatus is in an intermediate configuration between the rake configuration and the tamper configuration.

6. The apparatus of claim 1, further comprising rake teeth extending from the individual tines of the tines component.

7. The apparatus of claim 1, further comprising ribbed portions disposed on a surface of said tamper component opposite from the second end of the handle component.

8. The apparatus of claim 1, wherein the tine guides comprise apertures in the tamper component through which the individual tines extend.

9. The apparatus of claim 1, further comprising a locking mechanism integrated with the collar that locks the collar in place on the handle component.

10. The apparatus of claim 9, wherein the locking mechanism comprises a lever comprising a release end and a locking end.

11. The apparatus of claim 10, wherein pushing on the release end lifts the locking end away from the handle component allowing the collar to slide.

12. The apparatus of claim 10, wherein the locking mechanism comprises a spring disposed under the release end of the lever and a locking pin extending from the locking end of the lever.

13. The apparatus of claim 12, wherein the locking mechanism comprises a pivoting pin disposed between the release end and the locking end of the lever, and wherein the spring pushes the release end away from the handle component, pushing the locking end and the locking pin towards the handle component about the pivoting pin.

14. The apparatus of claim 12, wherein the handle component comprises a plurality of pin receiving holes that receive the locking pin, and wherein the pin receiving holes correspond to at least one of a rake configuration, a tamper configuration, and an intermediate configuration between the rake configuration and the tamper configuration.

15. The apparatus of claim 1, further comprising a hole disposed at the second end of the handle component.

16. The apparatus of claim 1, further comprising a grasping portion disposed at the second end of the handle component.

17. The apparatus of claim 16, wherein the grasping portion is made of rubber.

18. A method of operating an apparatus comprising a handle component, a tines component, a tamper component, and a collar, the method comprising:
extending the collar towards the tamper component to flare the tines component into a rake configuration; and
retracting the collar away from the tamper component to retract the tines component into a tamper configuration.
